(19) United States
(12) Patent Application Publication
(10) Pub. No.: US 2023/0256641 A1
(43) Pub. Date: Aug. 17, 2023

(54) BLADE MOVING DEVICE, BLADE HOLDING AND CHANGING APPARATUS AND MICROTOME

(71) Applicant: Leica Biosystems Nussloch GmbH, Nussloch (DE)

(72) Inventors: Zheguang FAN, Pudong, Shanghai (CN); Hongjian TAO, Pudong, Shanghai (CN)

(21) Appl. No.: 17/773,493

(22) PCT Filed: Oct. 30, 2019
(86) PCT No.: PCT/CN2019/114294

§ 371 Date: Apr. 29, 2022

(51) Int. Cl. B26D 7/26; G01N 1/06

(52) U.S. Cl. CPC B26D 7/2614; G01N 1/06; G01N 2001/061; G01N 2001/066

(57) ABSTRACT

A blade moving device includes: a support base; a linear bushing arranged in the support base; a moving block received in the support base and movably fitted over the linear bushing; a touch connector connected to the moving block and configured to move along with the moving block; and a blade box connected to the support base and configured to receive a blade therein. The touch connector is further configured to touch and push the blade to move out of the blade box when moving along with the moving block.

### FIELD

Embodiments of the present disclosure generally relate to a microtechnic filed, more particularly, to a blade moving device, a blade holding and changing apparatus and a microtome.

### BACKGROUND ART

In a present microtome, if a used blade needs to be changed, a user has to use his/her thumb to push a new blade out of a new blade box with one hand holding the new blade box, and then usually uses the thumb together with the other hand to pick the new blade and insert the new blade into a blade holder. In order to unload the used bladed from the blade holder, the user has to unclamp the blade holder, then pushes the used blade out of the blade holder and picks the used blade out of the blade holder, and finally puts the used blade into a used blade box or somewhere as required.

Thus, when loading or unloading the blade, the user has to move his/her hands frequently for operations and thus tends to be tired or even hurt. Further, aligning the new blade with the blade holder when inserting the new blade into the blade holder by hands has a low operation precision.

### SUMMARY

Embodiments of the present disclosure seek to solve at least one of the problems existing in the prior art to at least some extent, and thus provide blade moving device, a blade holding and changing apparatus and a microtome.

According to embodiments of a first broad aspect of the present disclosure, there is provided a blade moving device. The blade moving device includes: a support base; a linear bushing arranged in the support base; a moving block received in the support base and movably fitted over the linear bushing; a touch connector connected to the moving block and configured to move along with the moving block; and a blade box connected to the support base and configured to receive a blade therein. The touch connector is further configured to touch and push the blade to move out of the blade box when moving along with the moving block.

In the blade moving device according to embodiments of the present disclosure, the blade in the blade box can be moved out of the blade box without contact of the user with the blade, such that the user will not have a risk of being hurt by the blade and does not need to operate the new blade frequently, thus improving the safety of the user and simplifying the operation of the user.

In some embodiments, the support base includes: a bottom wall; two opposite side walls arranged at two ends of the bottom wall and extending upwards from the bottom wall, respectively; and a back wall arranged between the two opposite side walls and extending upwards from the bottom wall.

In some embodiments, two ends of the linear bushing pass through the two opposite side walls of the support base 11 and fixed therein, respectively. The moving block has a unthreaded hole therein, and the linear bushing extends through the unthreaded hole.

In some embodiments, the blade box is connected to the back wall of the support base and defines a receiving groove therein to receive the blade. The touch connector includes: a first section connected to the moving block and arranged parallel to the bottom wall of the support base; and a second section extending upwards from the first segment and facing towards the blade box.

In some embodiments, the second section of the touch connector is inclined with respect to the back wall of the support base, a part of a surface of the blade box facing towards the second section of the touch connector is inclined to be parallel with the second section, and the receiving groove is formed in the part of the surface of the blade box.

In some embodiments, the touch connector further includes a touch protrusion protruding from the second section of the touch connector towards the receiving groove, and the touch protrusion is configured to extend into the receiving groove, abut against an end of the blade and push the blade to move out of the blade box when the touch connecter moves along with the moving block.

In some embodiments, the blade moving device further includes: a motor arranged on the bottom wall of the support base and including a driving shaft passing through one of the two side walls of the support base; a lead screw received in the support base and having two ends passing through the two opposite side walls of the support base and fixed therein, respectively; two timing belt pulleys arranged close to the side wall of the support base through which the driving shaft passes, one of the two timing belt pulleys being arranged to the driving shaft of the motor, and the other one of the two timing belt pulleys being arranged to the lead screw; and a timing belt fitted over the two timing belt pulleys.

In some embodiments, the moving block has a threaded hole therein, and the lead screw extends through the threaded hole.

In some embodiments, the lead screw has external threads, the threaded hole has internal threads, and the lead screw is threadedly fitted in the threaded hole via the external threads and the internal threads and configured to drive the moving block to move.

In some embodiments, the blade moving device further includes an operation member arranged to the touch connector and configured to be operated to move the touch connector.

In some embodiments, the operation member is arranged on a surface of the touch connector facing away from the blade box.

In some embodiments, the operation member is integral with the touch connector.

According to embodiments of a second broad aspect of the present disclosure, there is provided a blade holding and changing apparatus. The blade holding and changing apparatus includes: a blade holder configured to clamp a used blade; a used blade box connected to the blade holder and configured to receive the used blade to be removed out of the blade holder; a blade moving device according to above embodiments of the present disclosure, the used blade box and the blade moving device being arranged to two opposite sides of the blade holder, respectively, and the blade moving device being configured to receive an unused blade therein and move the unused blade towards the used blade to replace the used blade with the unused blade.

In the blade holding and changing apparatus according to embodiments of the present disclosure, the used blade in the blade clamping unit can be replaced with the new blade in the blade moving device accurately and smoothly, without the contact of the user with the used blade and the new blade, such that it is convenient to change the used blade and the user has no risk of being hurt by the used blade and the new blade. Thus, the efficiency and precision of changing the used blade is increased and the safety of the user is improved.

In some embodiments, the blade holder includes: a base; and a blade clamping unit arranged on the base and configured to clamp the used blade. The blade moving device, the blade clamping unit and the used blade box are arranged in a straight line so that the unused blade is aligned with the used blade.

In some embodiments, the blade clamping unit includes: a clamping seat having a top surface; a clamping plate covered on the top surface of the clamping seat and rotatably connected to the clamping seat via a rotation shaft; a clamping push head received in the clamping seat, extending out of the top surface of the clamping seat and configured to move in a direction substantially perpendicular to the top surface of the clamping seat; and a drive member received in the clamping seat, connected to the clamping push head and configured to drive the clamping push head to move.

In some embodiments, the top surface of the clamping seat includes two oblique segments inclined at different angles. One end of the clamping plate is connected to the clamping seat via the rotation shaft, the one end of the clamping plate has an inclined surface matched with a corresponding one of the two oblique segments of the top surface of the clamping seat, so as to define a gap therebetween, and the gap is configured to receive the used blade and/or the unused blade therein. The corresponding one of the two oblique segments is inclined at a larger angle than the other one of the two oblique segments with respect to the base.

In some embodiments, the clamping push head has a free end configured to push the other end of the clamping plate away from the top surface of the clamping seat, in which the other end of the clamping plate faces away from the one end of the clamping plate.

According to embodiments of a third broad aspect of the present disclosure, there is provided a microtome. The microtome includes: a blade holding and changing apparatus according to above embodiments of the present disclosure, the blade holding and changing apparatus including a blade moving device according to part of above embodiments of the present disclosure; an operator interface unit configured to receive an input and generate an instruction according to the input; and a control unit coupled to the blade holding and changing apparatus and the operator interface unit, and configured to receive the instruction from the operator interface unit and control the blade holding and changing apparatus according to the instruction.

In some embodiments, the control unit is configured to: control the motor to drive the moving block to move in a first direction along the linear bushing, to drive the touch connector to move towards the blade holder, so as to push the unused blade to move towards the used blade; and control the motor to drive the moving block to move in a second direction until the touch connector returns to its original position, after the used blade is replaced with the unused blade, in which the second direction is opposite to the first direction.

In some embodiments, the operator interface unit includes at least one of a mechanical button or a liquid crystal display or a light emitting diode or a flexible display with control functions.

For the microtome according to embodiments of the present disclosure, the user can make an input via the operator interface unit so as to control the blade holding and changing apparatus to achieve a replacement of the used blade, instead of touching and operating the used blade and the new blade directly, such that it is convenient to change the used blade and the user has no risk of being hurt by the used blade and the new blade. Thus, the efficiency and precision of changing the used blade is increased and the safety of the user is improved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings.

FIG. 1 is a schematic view of a blade holding and changing apparatus according to an embodiment of the present disclosure.

FIG. 2 is a schematic view of a blade moving device according to an embodiment of the present disclosure.

FIG. 3 is a side view of the blade moving device illustrated in FIG. 2.

FIG. 4 is a partially enlarged view of portion A in FIG. 3.

FIG. 5 is a schematic view of a blade moving device according to another embodiment of the present disclosure.

FIG. 6 is a partial schematic view of the blade holding and changing apparatus illustrated in FIG. 1, in which a used blade is being replaced with a new blade.

FIG. 7 is a perspective view of a blade clamping unit according to an embodiment of the present disclosure.

FIG. 8 is a side view of the blade clamping unit in FIG. 7.

FIG. 9 is a schematic view of the blade clamping unit in FIG. 7, in which a clamping plate is removed.

FIG. 10 is a schematic view of a drive member and a clamping push head of the blade clamping unit in FIG. 7.

FIG. 11 is a perspective view of a microtome according to an embodiment of the present disclosure.

FIG. 12 is a block diagram of a microtome according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, Unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or element orientation (such as, for example, terms like “central,” “upper,” “lower,” “front,” “rear,” and the like) are only used to simplify description of the present disclosure, and do not alone indicate or imply that the device or element referred to must have a particular orientation.

In addition, terms such as “first” and “second” are used herein for purposes of description and are not intended to indicate or imply relative importance or significance.

Embodiments of the present disclosure provide a blade moving device 1. As illustrated in FIGS. 2-4, the blade moving device 1 according to embodiments of the present disclosure includes a support base 11, a motor 12, a timing belt 13, a timing belt pulley 14, a lead screw 15, a linear bushing 16, a moving block 17, a touch connector 18 and a blade box 19.

In some embodiments of the present disclosure, the support base 11 has a bottom wall 111 and two side walls 112 extending upwards from the bottom wall. The two side walls 112 are arranged at two ends of the bottom wall 111, respectively, and opposite to each other. The support base 11 further includes a back wall 113 extending upwards from the bottom wall 111, and the back wall 113 is arranged between the two side walls 112 and connected to the two side walls 112, respectively.

Further, each of the two side walls 112 has a top surface facing away from the bottom wall 111, and the top surface includes a first segment 1121 parallel to the bottom wall 111 and a second segment 1122 connected to the first segment 1121 and inclined from the first segment 1121 to the bottom wall 11.

As illustrated in FIG. 2, the motor 12 is arranged on the bottom wall 111 of the support base 11 and includes a driving shaft passing through the side wall 112 of the support base 11. For example, the side wall 112 has a hole aligned with the driving shaft of the motor 12, and the driving shaft of the motor 12 extends through the hole in the side wall 112. In some embodiments of the present disclosure, the motor 12 may be a rotary motor or a linear motor.

Moreover, two ends of the lead screw 15 pass through the two side walls 112 of the support base 11 and fixed therein, respectively. In the embodiments illustrated in FIG. 2, two timing belt pulleys 14 are provided and arranged at a same side of the support base 11, i.e. close to the side wall 112 of the support base 11 through which the driving shaft passes. One of the two timing belt pulleys 14 is arranged to the driving shaft of the motor 12, and the other one of the two timing belt pulleys 14 is arranged to the lead screw 15. Further, the timing belt 13 is fitted over the two timing belt pulleys 14 and carried by the two timing belt pulleys 14.

Further, two ends of the linear bushing 16 also pass through the two side walls 112 of the support base 11 and fixed therein, respectively. Both the lead screw 15 and the linear bushing 16 pass through the moving block 17. In other words, the moving block 17 is fitted over the lead screw 15 and the linear bushing 16, and is movable along the lead screw 15 and the linear bushing 16.

Specifically, the moving block 17 has a threaded hole and an unthreaded hole therein, the linear bushing 16 extends through the unthreaded hole, and the lead screw 15 extends through the threaded hole. Further, the lead screw 15 has external threads and the threaded hole has internal threads, such that the lead screw 15 can be threadedly fitted in the threaded hole via the external threads and the internal threads, and also drive the moving block 17 to move by rotating, thus converting the rotation of the lead screw 15 into the translation of the moving block 17. In some embodiments of the present disclosure, the linear bushing 16 may be a ball or roller guider. Further, the lead screw 15 has high precision such that the moving block 17 can be moved precisely.

In this case, when the motor 12 acts to drive the driving shaft to rotate, the driving shaft will also drive the timing belt pulley 14 arranged thereon to rotate, such that the timing belt 13 fitted over the timing belt pulley 14 will be driven to move, thus driving the other timing belt pulley 14 to rotate. Therefore, the other timing belt pulley 14 will drive the lead screw 15 to rotate in turn. The rotation of the lead screw 15 will be transferred into the translation of the moving block 17 due to the threaded connection between the lead screw 15 and the moving block 17, such that the moving block 17 will move along the linear bushing 16 under the drive of the lead screw 15.

In some embodiments of the present disclosure, the above timing belt driven system may be a gear driven system or a system in which the ball screw is directly driven by the motor.

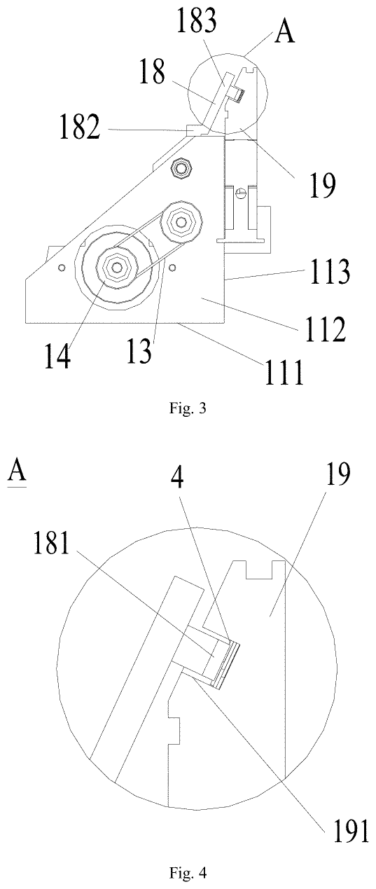

As further illustrated in FIGS. 2-3, the touch connector 18 is connected to the moving block 17, for example by screws or bolts, such that the moving block 17 can drive the touch connector 18 to move. In other embodiments of the present disclosure, the touch connector 18 may be integral with the moving block 17. Further, the blade box 19 is connected to the back wall 113 of the support base 11, and the blade box 19 is configured to receive a new blade 4, i.e. an unused blade therein. The touch connector 18 is configured to touch and drive the new blade 4 to move, such that the new blade 4 received in the blade box 19 can be translated when the moving block 17 is driven to move along the linear bushing 16.

As illustrated in FIG. 4, the blade box 19 defines a receiving groove 191 therein, and the new blade 4 is received in the receiving groove 191. Accordingly, the touch connector 18 includes a touch protrusion 181 protruding from a surface of the touch connector 18 facing towards the blade box 19. The touch protrusion 181 extends into the receiving groove 191 and abuts against an end of the new blade 4. Specifically, a free end of the touch protrusion 181 is arranged at a side of the new blade 4, and located between a top surface and a bottom surface of the new blade 4 with respect to a bottom of the receiving groove 191, such that the touch protrusion 181 is configured to push the new blade 4 to move when the touch connector 18 is driven by the moving block 17 to move.

In some embodiments of the present disclosure, a plurality of new blades 4 may be provided in the receiving groove 191, as illustrated in FIG. 4. The plurality of new blades 4 may be arranged one on another in the receiving groove 191, and the touch protrusion 181 is configured to push one new blade 4 to move out of the receiving groove 191 at a time. After the one new blade 4 is removed out of the receiving groove 191, the touch connector 18 returns to its original position and the touch protrusion 181 extends deeper in the receiving groove 191 so as to abut against an end of another new blade 4 for the movement of such new blade 4. For example, the touch protrusion 181 has an adjustable length and thus can adjust its length according to actual requirements, so as to abut against the ends of different new blades 4 in the receiving groove 191.

In other embodiments, the touch connector 18 may be not configured to extend deeper in the receiving groove 191, but the plurality of new blades 4 may be configured to move towards the touch connector 18, after the one new blade 4 is removed out of the receiving groove 191, and the touch connector 18 returns to its original position. For example, the plurality of new blades 4 may be arranged on an elastic member, and the elastic member is configured to push the plurality of new blades 4 towards the touch connector 18.

Further, the touch connector 18 has an end in contact with the new blade 4, the end of the touch connector 18 has a step in its edge facing towards the new blade 4, and a part of the new blade 4 is received in the step, such that the touch connector 18 can push the new blade 4 to move towards the used blade 5 and also prevent such new blade 4 from moving towards the touch connector 18 under the action of the elastic member.

During the movement of the touch connector 18 back to its original position, the end of the touch connector 18 will abut against a surface of a next new blade 4 facing towards the touch connector 18, such that the next new blade 4 will not move to a position where it is aligned with the used blade 5, until the touch connector 18 arrives at its original position. Then, the end of the touch connector 18 will not prevent the next new blade 4 from moving towards the touch connector 8, and a part of the next new blade 4 will be received in the step, just as the prior new blade 4. Thus, the next blade replacement is ready.

Further, as illustrated in FIG. 3, the touch connector 18 includes a first section 182 and a second section 183, the first section 182 is connected to the moving block 17 and arranged parallel to the bottom wall 111 of the support base 11, and the second section 183 extends upwards from the first segment 182 and is inclined with respect to the back wall 113 of the support base 11.

Accordingly, a part of a surface of the blade box 19 facing towards the second section 182 is inclined to be parallel with the second section 182, in which the receiving groove 191 is formed in the part of the surface of the blade box 19, and the touch protrusion 181 protrudes from the second section 182 towards the receiving groove 191, such that the second section 182 of the touch connector 18 can be better fitted with the surface of the blade box 19, and thus the touch protrusion 181 can push the new blade 4 to move smoothly.

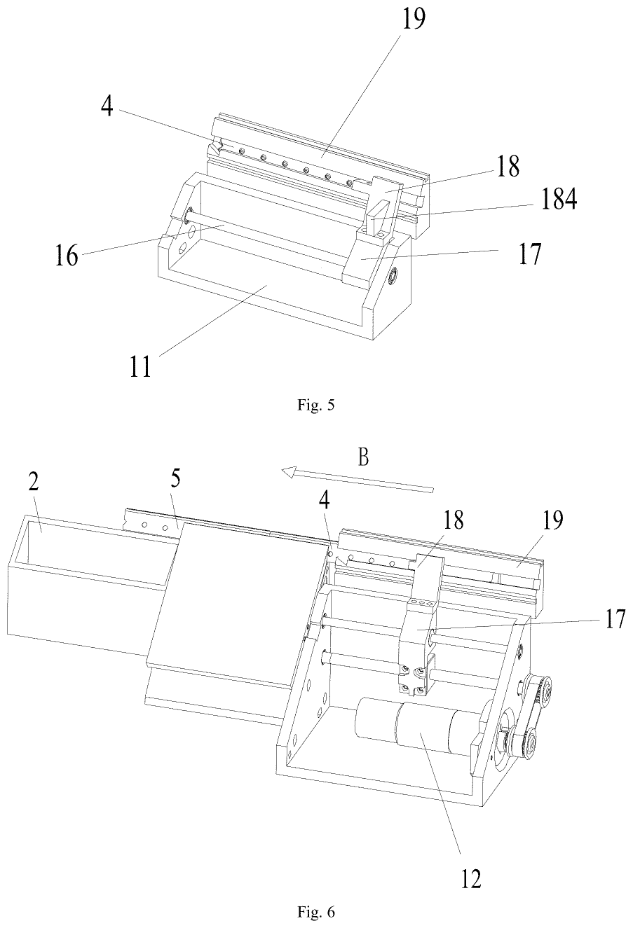

In another embodiment of the present disclosure, as illustrated in FIG. 5, the blade moving device 1 does not include the motor 12, the timing belt 13, the timing belt pulley 14, and the lead screw 15. Instead, the blade moving device 1 includes an operation member 184 arranged to the touch connector 18. Specifically, the operation member 184 is arranged on a surface of the touch connector 18 facing away from the blade box 19. Further, a longitudinal section of the operation member 184 has a shape corresponding to that of a longitudinal section of the touch connector 18, such that the operation member 184 can be stably mounted on the touch connector 18.

In some embodiments of the present disclosure, the operation member 184 may be integral with the touch connector 18, and extend from the surface of the touch connector 18 facing away from the blade box 19.

In the embodiment illustrated in FIG. 5, the operation member 184 is configured to be operated by the user to move the touch connector 18 and the moving block 17 along the linear bushing 16, so as to push the new blade 4 out of the blade box 19.

Moreover, the other parts of the blade moving device 1 illustrated in FIG. 5 are same with those of the blade moving device 1 illustrated in FIGS. 2-4, and thus will not be described again herein.

In the blade moving device according to embodiments of the present disclosure, the new blade 4 in the blade box 19 can be moved out of the blade box 19 without contact of the user with the new blade 4, such that the user will not have a risk of being hurt by the new blade 4 and does not need to operate the new blade frequently, thus improving the safety of the user and simplifying the operation of the user.

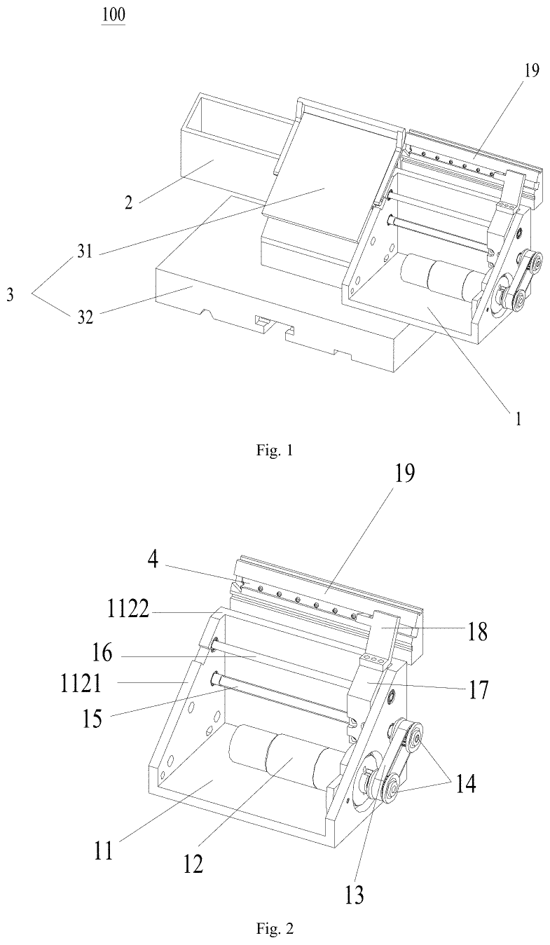

Embodiments of the present disclosure also provide a blade holding and changing apparatus 100, as illustrated in FIG. 1. The blade holding and changing apparatus 100 according to embodiments of the present disclosure includes a blade holder 3, a used blade box 2 and the blade moving device 1 according to the above embodiments of the present disclosure.

The blade holder 3 includes a blade clamping unit 31 and a base 32, and the blade clamping unit 31 is arranged on the base 32. The blade clamping unit 31 is configured to clamp a blade and the base 332 carries the blade clamping unit 41 thereon. Further, the blade moving device 1 and the used blade box 2 are connected to two opposite sides of the blade holder 3, respectively.

In some embodiments of the present disclosure, the blade moving device 1 and the used blade box 2 may also be arranged on the base 32, respectively.

As also illustrated in FIG. 1, the blade moving device 1, the blade clamping unit 31, and the used blade box 2 are arranged in a straight line, such as in a moving direction of the new blade 4 received in the blade box 19. Further, the new blade 4 is aligned with the blade, i.e. a used blade 5, clamped in the blade clamping unit 31, such that the new blade 4 can push the used blade 5 out of the blade clamping unit 31 and into the used blade box 2, when the new blade 4 is moved out of the blade box 19. Thus, the used blade 5 in the blade clamping unit 31 will be replaced with the new blade 4.

Specifically, as illustrated in FIG. 6, when the motor 12 operates to drive the moving block 17 to move in a direction B along the linear bushing 16, the touch connector 18 will also be driven by the moving block 17 to move towards the blade holder 3, such that the touch connector 18 will push the new blade 4 to move towards the used blade 5. Consequently, the new blade 4 abuts against the used blade 5, and pushes the used blade 5 to move out of the blade clamping unit 31, until the whole new blade 4 is received in the blade clamping unit 331, and the whole used blade 5 is removed out of the blade clamping unit 31 and fallen into the used blade box 2.

Subsequently, the motor 12 drives the moving block 17 to move in a reverse direction, such that the touch connector 18 returns to its original position, so as to be ready for another blade replacement.

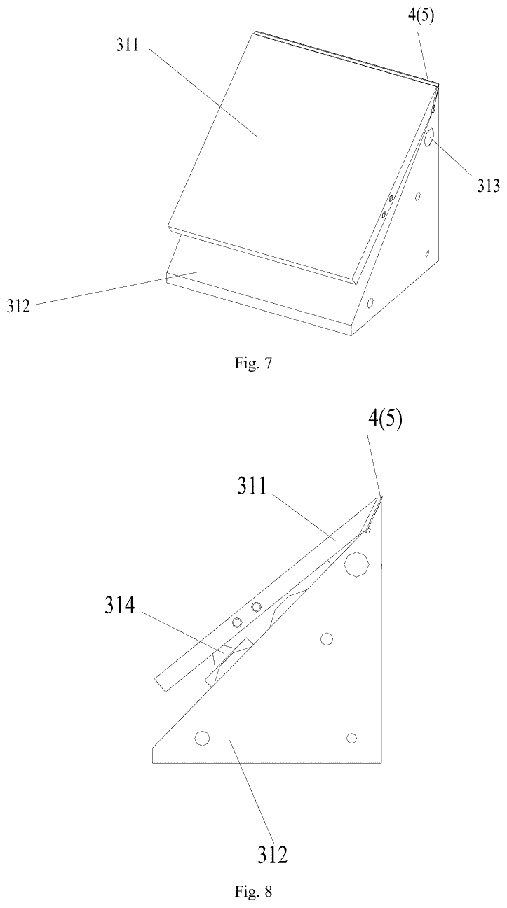

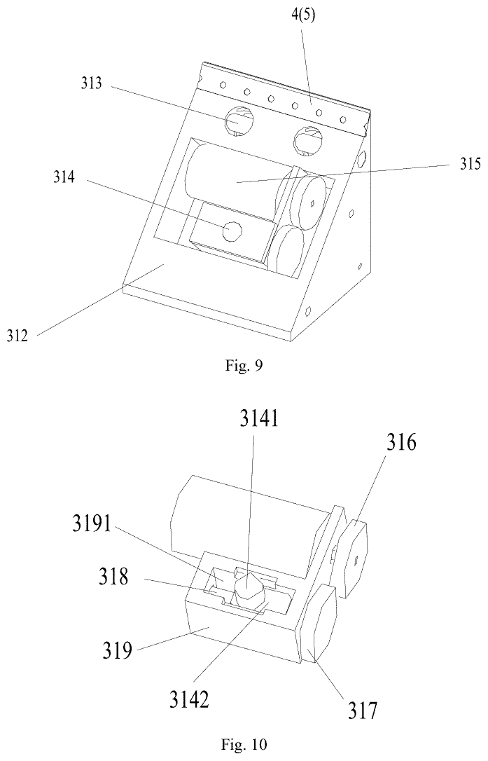

In some embodiments of the present disclosure, as illustrated in FIGS. 7-10, the blade clamping unit 31 includes a clamping plate 311, a clamping seat 312, a rotation shaft 313, a clamping push head 314, and a drive member 315.

The clamping seat 312 has a top surface which includes two oblique segments inclined at different angles. The clamping plate 311 is covered on the top surface of the clamping seat 312, and rotatably connected to the clamping seat 312 via the rotation shaft 313. That is, the clamping plate 311 is connected to the clamping seat 312 and can be rotated with respect to the clamping seat 312 via the rotation shaft 313.

Specifically, one end of the clamping plate 311 is connected to the clamping seat 312 via the rotation shaft 313. The one end of the clamping plate 311 also has an inclined surface matched with a corresponding one (for example an upper one in FIG. 8) of the two oblique segments of the top surface of the clamping seat 312, so as to define a gap therebetween, and thus the used blade or the new blade 4 may be clamped in the gap. The corresponding one of the two oblique segments is inclined at a larger angle than the other one of the two oblique segments with respect to the base 32.

Further, the clamping push head 314 and the drive member 315 are received in the clamping seat 312, and the clamping push head 314 is connected to the drive member 315. The drive member 315 is configured to drive the clamping push head 314 to move. The clamping push head 314 extends out of the top surface of the clamping seat 312 and configured to move in a direction substantially perpendicular to the top surface of the clamping seat 312 under an action of the drive member 315.

For example, the clamping push head 314 may be connected to the drive member 315 via gears. Specifically, as illustrated in FIG. 10, the drive member 315 is connected to a first gear 316 and configured to drive the first gear 316 to rotate. The first gear 316 meshes with a second gear 317. The second gear 317 is connected to an eccentric shaft 318 and configured to drive the eccentric shaft 318 to rotate.

Further, the clamping push head 314 include a free end 3141 and a wedge block 3142. The free end 3141 is arranged on the wedge block 3142 and configured to abut against the other end of the clamping plate 311. The wedge block 3142 is arranged on the eccentric shaft 318 and in contact with the eccentric shaft 318. In addition, the blade clamping unit 31 further includes a receptacle 319, and the eccentric shaft 318 is rotatably received in the receptacle 319 and extends out of the receptacle 319 to be connected to the second gear 317. The receptacle 319 has a receiving groove 3191 opened towards the clamping plate 311, and the wedge block 3142 is fitted in the receiving groove 3191 and configured to move along the receiving groove 3191 in the direction substantially perpendicular to the top surface of the clamping seat 312, so as to carry the free end 3141 move up and down.

In this case, when the drive member 315 operates, the eccentric shaft 318 is rotated, and different parts of a periphery of the eccentric shaft 318, which have different radial distances relative to an axis of the second gear 317, will be in contact with and abut against the clamping push head 314, such that the clamping push head 314 will move up and down in the direction substantially perpendicular to the top surface of the clamping seat 312 during the rotation of the eccentric shaft 318.

For example, when a part of the periphery of the eccentric shaft 318, which has a large radial distance relative to the axis of the second gear 317, is in contact with and abuts against the clamping push head 314, the clamping push head 314 will be pushed out towards the clamping plate 311. Or, when another part of the periphery of the eccentric shaft 318, which has a small radial distance relative to the axis of the second gear 317, is in contact with and abuts against the clamping push head 314, the clamping push head 314 will be retracted into the receptacle 319 under the action of gravity.

In the embodiments illustrated in FIGS. 7-10, when the blade clamping unit 31 needs to clamp the blade tightly, the drive member 315 drives the clamping push head 314 to extend outwards such that the free end of the clamping push head 314 pushes the other end of the clamping plate 311 away from the top surface of the clamping seat 312, and thus the clamping plate 311 will rotate around the rotation shaft 313 in a clockwise direction with respect to the clamping seat 312. In this way, the gap between the surface of the one end of the clamping seat 312 and the upper segment of the top surface of the clamping seat 312 will be narrowed, such that the blade can be clamped tightly.

When the blade clamping unit 31 needs to release the blade, for example the used blade 5 needs to be replaced with the new blade 4, the drive member 315 drives the clamping push head 314 to contract inwards, such that the other end of the clamping plate 311 moves towards the top surface of the clamping seat 312 under the action of gravity, and thus the clamping plate 311 will rotate around the rotation shaft 313 in a counterclockwise direction with respect to the clamping seat 312. In this way, the gap between the surface of the one end of the clamping seat 312 and the upper segment of top surface of the clamping seat 312 will be widened, such that the blade can be moved.

In this case, when the new blade 4 in the blade box 19 is moved towards the used blade 5 clamped in the blade clamping unit 31, the used blade 5 can be pushed to move out of the blade clamping unit 31 and finally fallen into the used blade box 2, such that the used blade 5 can be replaced with the new blade 4, just as described above.

In the blade holding and changing apparatus 100 according to embodiments of the present disclosure, the used blade 5 in the blade clamping unit 31 can be replaced with the new blade 4 in the blade moving device 1 accurately and smoothly, without the contact of the user with the used blade 5 and the new blade 4, such that it is convenient to change the used blade 5 and the user has no risk of being hurt by the used blade 5 and the new blade 4. Thus, the efficiency and precision of changing the used blade 5 is increased and the safety of the user is improved.

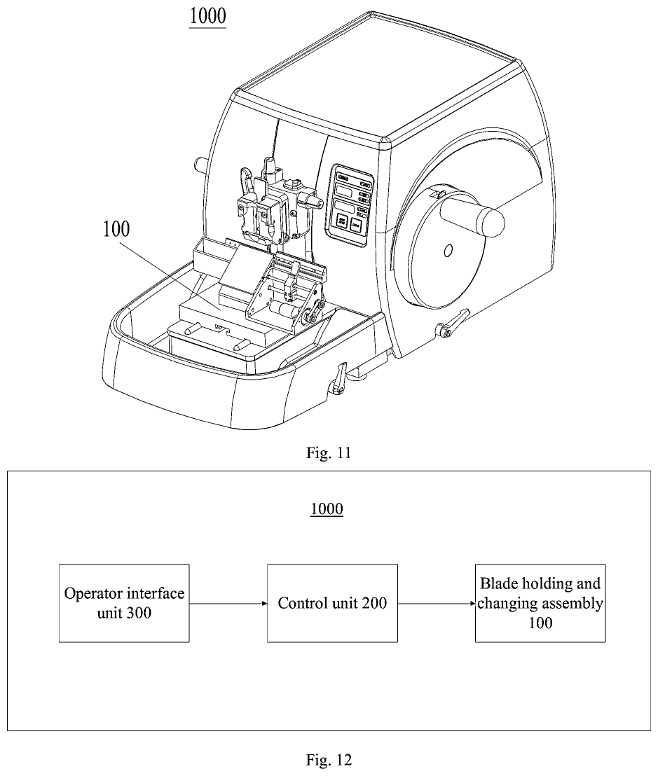

Embodiments of the present disclosure further provide a microtome 1000, as illustrated in FIG. 11 and FIG. 12. The microtome 1000 includes the blade holding and changing apparatus 100 according to the above embodiments illustrated in FIGS. 1-4 and 6-10, a control unit 200 and an operator interface unit 300.

The control unit 200 is coupled to the blade holding and changing apparatus 100, and the operator interface unit 300 is coupled to the control unit 200. The operator interface unit 300 is configured to receive an input from the user, generate an instruction according to the input of the user and further send the instruction to the control unit 200. The control unit 200 is configured to receive the instruction and control the blade holding and changing apparatus 100 to load or unload the blade.

For example, when the user makes an input of changing the blade, the operator interface unit 300 receives the input, generates a changing instruction according to the input and sends the changing instruction to the control unit 200. The control unit 200 receives the changing instruction and controls the blade holding and changing apparatus 100 to operate according to the changing instruction, so as to change the used blade 5 with the new blade 4, just as described according to the above embodiments illustrated in FIGS. 1-4 and 6-10.

Specifically, the control unit 200 controls the motor 12 to drive the moving block 17 to move in the direction B along the linear bushing 16, the touch connector 18 will also be driven by the moving block 17 to move towards the blade holder 3, such that the touch connector 18 will push the new blade 4 to move towards the used blade 5. Consequently, the new blade 4 abuts against the used blade 5, and pushes the used blade 5 to move out of the blade clamping unit 31, until the whole new blade 4 is received in the blade clamping unit 331, and the whole used blade 5 is removed out of the blade clamping unit 31 and fallen into the used blade box 2.

Further, the control unit 200 is further configured to control the motor 12 to drive the moving block 17 to move in a reverse direction, such that the touch connector 18 returns to its original position, so as to be ready for another blade replacement.

In some embodiments of the present disclosure, the operator interface unit may be a mechanical button or a liquid crystal display (LCD) or a light emitting diode (LED) or a flexible display with control functions.

For the microtome 1000 according to embodiments of the present disclosure, the user can make an input via the operator interface unit 300 so as to control the blade holding and changing apparatus 100 to achieve a replacement of the used blade 5, instead of touching and operating the used blade 5 and the new blade 4 directly, such that it is convenient to change the used blade 5 and the user has no risk of being hurt by the used blade 5 and the new blade 4. Thus, the efficiency and precision of changing the used blade 5 is increased and the safety of the user is improved.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

1. A blade moving device, comprising:
a support base;
a linear bushing arranged in the support base;
a moving block received in the support base and movably fitted over the linear bushing;
a touch connector connected to the moving block and configured to move along with the moving block; and
a blade box connected to the support base and configured to receive a blade therein, the touch connector being further configured to touch and push the blade to move out of the blade box when moving along with the moving block.

2. The blade moving device according to claim 1, wherein the support base comprises:
a bottom wall;
two opposite side walls arranged at two ends of the bottom wall and extending upwards from the bottom wall, respectively; and
a back wall arranged between the two opposite side walls and extending upwards from the bottom wall.

3. The blade moving device according to claim 2, wherein two ends of the linear bushing pass through the two opposite side walls of the support base and fixed therein, respectively;
wherein the moving block has a unthreaded hole therein, and the linear bushing extends through the unthreaded hole.

4. The blade moving device according to claim 2, wherein the blade box is connected to the back wall of the support base and defines a receiving groove therein to receive the blade,
wherein the touch connector comprises:
a first section connected to the moving block and arranged parallel to the bottom wall of the support base; and
a second section extending upwards from the first section and facing towards the blade box.

5. The blade moving device according to claim 4, wherein the second section of the touch connector is inclined with respect to the back wall of the support base, a part of a surface of the blade box facing towards the second section of the touch connector is inclined to be parallel with the second section, and the receiving groove is formed in the part of the surface of the blade box.

6. The blade moving device according to claim 5, wherein the touch connector further comprises a touch protrusion protruding from the second section of the touch connector towards the receiving groove, and the touch protrusion is configured to extend into the receiving groove, abut against an end of the blade and push the blade to move out of the blade box when the touch connector moves along with the moving block.

7. The blade moving device according to claim 2, further comprising:
a motor arranged on the bottom wall of the support base and comprising a driving shaft passing through one of the two side walls of the support base;
a lead screw received in the support base and having two ends passing through the two opposite side walls of the support base and fixed therein, respectively;
two timing belt pulleys arranged close to the side wall of the support base through which the driving shaft passes, one of the two timing belt pulleys being arranged to the driving shaft of the motor, and the other one of the two timing belt pulleys being arranged to the lead screw; and
a timing belt fitted over the two timing belt pulleys.

8. The blade moving device according to claim 7, wherein the moving block has a threaded hole therein, and the lead screw extends through the threaded hole.

9. The blade moving device according to claim 8, wherein the lead screw has external threads, the threaded hole has internal threads, and the lead screw is threadedly fitted in the threaded hole via the external threads and the internal threads and configured to drive the moving block to move.

10. The blade moving device according to claim 1, wherein the blade moving device further comprises an operation member arranged to the touch connector and configured to be operated to move the touch connector.

11. The blade moving device according to claim 10, wherein the operation member is arranged on a surface of the touch connector facing away from the blade box.

12. The blade moving device according to claim 10, wherein the operation member is integral with the touch connector.

13. A blade holding and changing apparatus, comprising:
a blade holder configured to clamp a used blade;
a used blade box connected to the blade holder and configured to receive the used blade to be removed out of the blade holder; and
a blade moving device comprising:
a support base;
a linear bushing arranged in the support base;
a moving block received in the support base and movably fitted over the linear bushing;
a touch connector connected to the moving block and configured to move along with the moving block; and
a blade box connected to the support base and configured to receive a blade therein, the touch connector being further configured to touch and push the blade to move out of the blade box when moving along with the moving block;
wherein the used blade box and the blade moving device are arranged to two opposite sides of the blade holder, respectively, and the blade moving device is configured to receive an unused blade therein and move the unused blade towards the used blade to replace the used blade with the unused blade.

14. The blade holding and changing apparatus according to claim 13, wherein the blade holder comprises:
a base; and
a blade clamping unit arranged on the base and configured to clamp the used blade,
wherein the blade moving device, the blade clamping unit and the used blade box are arranged in a straight line so that the unused blade is aligned with the used blade.

15. The blade holding and changing apparatus according to claim 14, wherein the blade clamping unit comprises:
a clamping seat having a top surface;
a clamping plate covered on the top surface of the clamping seat and rotatably connected to the clamping seat via a rotation shaft;
a clamping push head received in the clamping seat, extending out of the top surface of the clamping seat and configured to move in a direction substantially perpendicular to the top surface of the clamping seat; and
a drive member received in the clamping seat, connected to the clamping push head and configured to drive the clamping push head to move.

16. The blade holding and changing apparatus according to claim 15, wherein the top surface of the clamping seat comprises two oblique segments inclined at different angles,
wherein one end of the clamping plate is connected to the clamping seat via the rotation shaft, the one end of the clamping plate has an inclined surface matched with a corresponding one of the two oblique segments of the top surface of the clamping seat, so as to define a gap therebetween, and the gap is configured to receive the used blade and/or the unused blade therein, in which the corresponding one of the two oblique segments is inclined at a larger angle than the other one of the two oblique segments with respect to the base.

17. The blade holding and changing apparatus according to claim 16, wherein the clamping push head has a free end configured to push the other end of the clamping plate away from the top surface of the clamping seat, in which the other end of the clamping plate faces away from the one end of the clamping plate.

18. A microtome, comprising:
a blade holding and changing apparatus comprising:
a blade holder configured to clamp a used blade;
a used blade box connected to the blade holder and configured to receive the used blade to be removed out of the blade holder; and
a blade moving device comprising:
a support base comprising: a bottom wall, two opposite side walls arranged at two ends of the bottom wall and extending upwards from the bottom wall, respectively, and a back wall arranged between the two opposite side walls and extending upwards from the bottom wall;
a linear bushing arranged in the support base;
a moving block received in the support base and movably fitted over the linear bushing;
a touch connector connected to the moving block and configured to move along with the moving block;
a blade box connected to the support base and configured to receive a blade therein, the touch connector being further configured to touch and push the blade to move out of the blade box when moving along with the moving block, wherein the used blade box and the blade moving device are arranged to two opposite sides of the blade holder, respectively, and the blade moving device is configured to receive an unused blade therein and move the unused blade towards the used blade to replace the used blade with the unused blade;
a motor arranged on the bottom wall of the support base and comprising a driving shaft passing through one of the two side walls of the support base;
a lead screw received in the support base and having two ends passing through the two opposite side walls of the support base and fixed therein, respectively;
two timing belt pulleys arranged close to the side wall of the support base through which the driving shaft passes, one of the two timing belt pulleys being arranged to the driving shaft of the motor, and the other one of the two timing belt pulleys being arranged to the lead screw; and
a timing belt fitted over the two timing belt pulleys;
an operator interface unit configured to receive an input and generate an instruction according to the input; and
a control unit coupled to the blade holding and changing apparatus and the operator interface unit, and configured to receive the instruction from the operator interface unit and control the blade holding and changing apparatus according to the instruction.

19. The microtome according to claim 18, wherein the control unit is configured to:
control the motor to drive the moving block to move in a first direction along the linear bushing, to drive the touch connector to move towards the blade holder, so as to push the unused blade to move towards the used blade; and
control the motor to drive the moving block to move in a second direction until the touch connector returns to its original position, after the used blade is replaced with the unused blade, in which the second direction is opposite to the first direction.

20. The microtome according to claim 18, wherein the operator interface unit comprises at least one of a mechanical button or a liquid crystal display or a light emitting diode or a flexible display with control functions.
